(19) United States
(12) Patent Application Publication
(10) Pub. No.: US 2006/0174495 A1
(43) Pub. Date: Aug. 10, 2006

(54) Constructive arrangement in a saw

(76) Inventor: Salvador Camargo Jumior, Itu (BR)

Correspondence Address: Hoffman Wasson & Gitler, Crystal Center 2 Suite 522, 2461 South Clark Street, Arlington, VA, 22202, US

(21) Appl. No.: 10/548,593

(22) PCT Filed: Mar. 23, 2004
(86) PCT No.: PCT/BR04/00038

§ 371 Date: Sep. 13, 2005

(30) Foreign Application Priority Data
Mar. 24, 2003 (BR) MU 8301911

(51) Int. Cl. B26B 1/00

(52) U.S. Cl. 30/339; 30/392; 30/166.3

(57) ABSTRACT

A constructive arrangement in a saw, of the type that comprises a thin laminar portion having a compatible standardized length, a serrated or indented profile being defined on its working edge that configures the cutting blade of the laminar saw itself, the free front free end of said laminar portion being defined by a beveled shape with rounded corners. The back coupling end (3) of the portion (10) is comprised of a “V” shaped (4) axially disposed along the body of the blade (10), followed by a through-hole (5) that is centered and aligned with the longitudinal axle of said blade (10), the through-hole (5) being disposed equidistant said “V” shaped edge (4) and small transversal thin tabs (6) incorporated to the side edge of this laminar portion (10), in a region immediately in front of the recesses (7, 7a) provided in the respective upper and lower side edges of the laminar portion (10), thus configuring a neck that prevents the back universal coupling end (3) from coupling with the rest of the body (1, 2) of the sawing blade (10) itself.

The present utility model is directed to a constructive arrangement in a saw, more specifically a jig type saw, said novel constructive arrangement precisely comprising the saw end that attaches same to the respective machine for actuating or operating the saw.

As is known by those skilled in the art, there are plenty of different types and trademarks of sawing devices in the market, including laminar saws known as “jig-saws”, characterized by being replaceable parts after they are worn out or broken.

Every model or trademark of the existing sawing devices presents a distinct particular attachment system, thus forcing the user to acquire cutting saws provided with their attachment end consistent with the coupling or fitting system of the device.

Although this condition presents at first a certain protectionism that favors the manufacturers of machines by specifying or associating the replaceable saw with the sawing device, it brings about a number of inconveniences at a later time, for it also creates an extensive dependence of the machine on the cutting tool.

One of these inconveniences is the fact that in the event there is a shortage of cutting tools in the replacement market, the sawing device becomes idle, a situation that causes problems to the user.

Another inconvenience is the fact that the user, when buying the sawing blades, must have in mind the exact type and model of machine he owns in order to buy the compatible saw, what does not occur all the time.

Another inconvenience of this diversity of models of machines and respective sawing blades is the fact that the salesman have must keep a spare supply in his store for every model and type of saw, thus requiring further space and storing cost and investment in goods, with respect to a good whose rotation cannot be predictable.

Another inconvenience of said diversity of saws is the fact that the manufacturer must keep a regulating supply, a production line and machinery for producing every type and/or model of sawing blades that are compatible with the innumerable types and models of the existing sawing devices.

Therefore one of the objects of the present invention is to provide a constructive arrangement in a saw that eliminates the possibility of a shortage of the cutting in the replacement market and, consequently, it prevents the eventual idleness of the sawing device.

Another object of the present invention is to provide a constructive arrangement in a saw that it does require the user to know precisely the type and model of machine he owns so that he can buy a type of compatible saw.

Another object of the present invention is to provide a constructive arrangement in a saw that does not require the salesman to keep a replacement supply in his store for every model and type of saw.

Another object of the present invention is to provide a constructive arrangement in a saw that does not require the manufacturer to keep: a regulating stock, a line of production and machinery for producing every type and/or model of sawing blades that are compatible with the innumerable types and models of sawing devices that the manufacturer himself sells.

These and other objects and advantages of the present invention are attained by a constructive arrangement in a saw that comprises a thin laminar portion having a compatible standardized length, a serrated or indented profile that configures the proper wire of cut of the laminar saw being defined on its working edge, the free front end of said laminar portion having a beveled shape with rounded corners, while in accordance with the present invention the back coupling end of said portion is provided with a “V” profile axially disposed along the blade body, followed by a circular through-hole that is centered and aligned with the axle of said blade, said circular hole being disposed equidistant said “V” axial edge and small rectangular transversal thin tabs incorporated to a side edge of said laminar portion, in a region immediately in front of a substantially trapezoidal recess provided in the respective side edges in the laminar portion, thus configuring a neck that prevents the back universal end from coupling with the rest of the body of the sawing blade itself.

The present invention will be described below with reference to the accompanying drawings, in which:

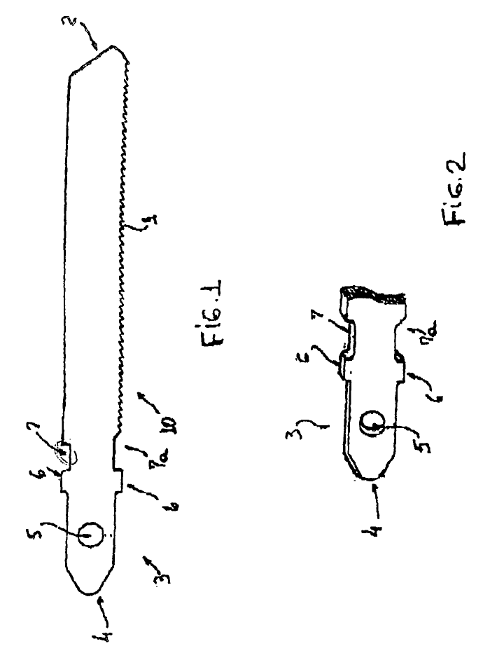

FIG. 1 shows a plan view of the inventive saw arrangement;

FIG. 2 shows a perspective detailed view of the coupling end of the saw according to the constructive arrangement shown in FIG. 1;

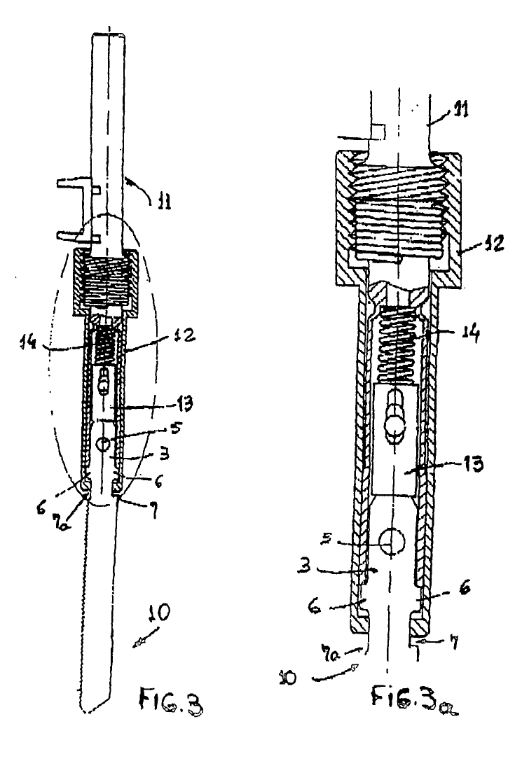

FIG. 3 shows a partially cut elevation view of the actuating pin of a Bosch® type sawing device having the inventive saw coupled thereto;

FIG. 3a shows an enlarged detailed view of the coupling sleeve of the actuating pin of a Bosch® type sawing device having the inventive saw coupled thereto;

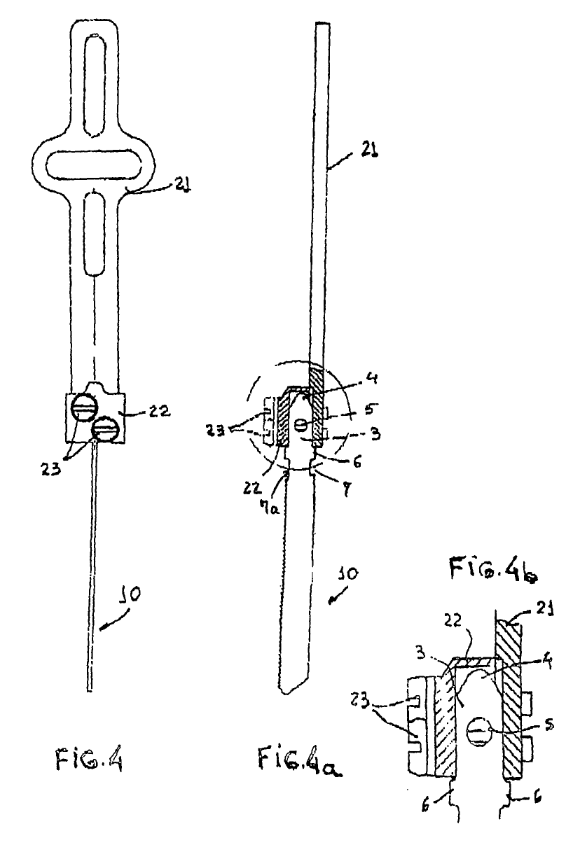

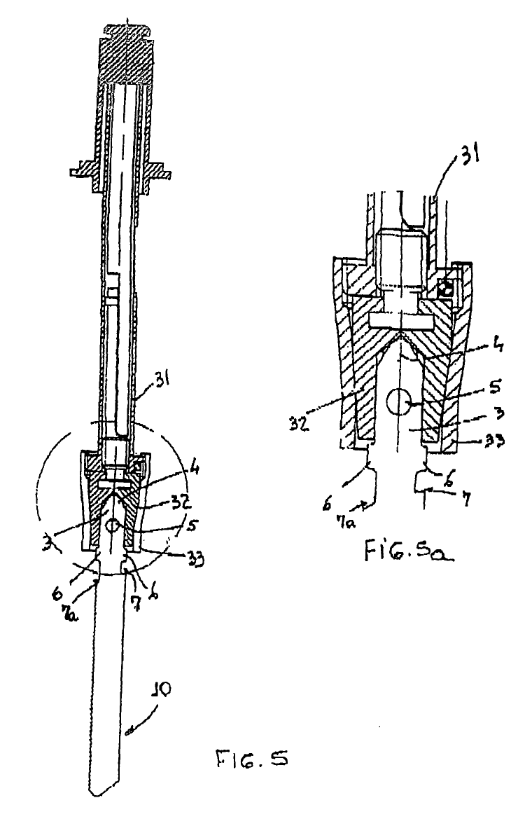

FIG. 4 shows an elevation view of the actuating pin of a Black & Decker® type sawing device having the inventive saw coupled thereto;

FIG. 4a shows another elevation view taken 90° to the previous figure showing in a partially cut view the coupling point of the actuating pin of a Black & Decker® type sawing device having the inventive saw coupled thereto;

FIG. 4b shows an enlarged detailed view of the coupling sleeve of the actuating pin of the Bosch® type sawing device having the inventive saw coupled thereto;

FIG. 5 shows a partially cut elevation view of the actuating pin of a De Walt® type sawing device having the inventive saw coupled thereto;

FIG. 5a shows an enlarged detailed view of the coupling sleeve of the actuating pin of a De Walt® type sawing device having the inventive saw coupled thereto;

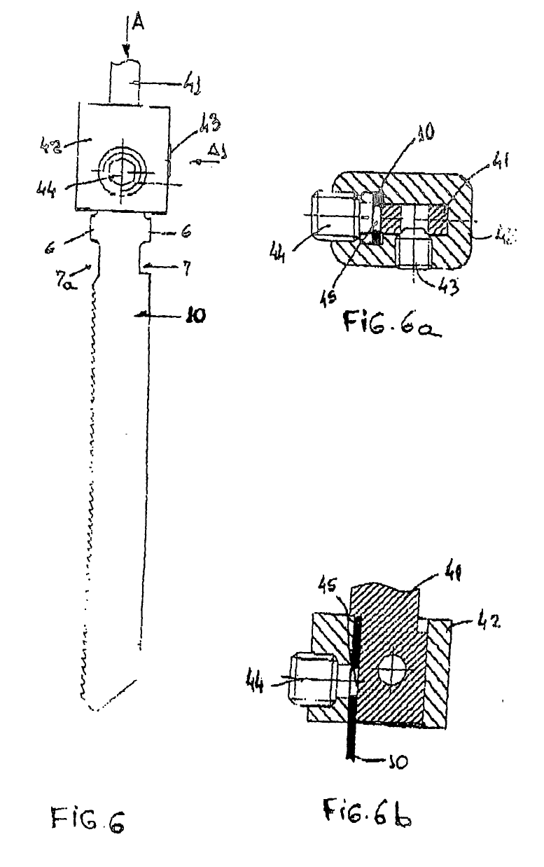

FIG. 6 shows an elevation view of the actuating pin of a B&D 3157 or DW 313 type sawing device having the inventive saw coupled thereto;

FIG. 6a shows a top view of an enlarged cross-section of the coupling sleeve of the actuating pin of a sawing device taken from arrow “A” of the previous figure; and

FIG. 6b shows a detailed partially cut front elevation view of the coupling sleeve of the actuating pin of a sawing device taken from arrow “A1” of FIG. 6.

According to these illustrations, the constructive arrangement in a saw object of the present invention comprises a thin laminar portion 10 having a compatible standardized length provided with a serrated working edge 1 that configures the cutting blade of the laminar saw 10 itself.

As can be seen in the figures, the free front end 2 of said laminar portion 10 is preferably beveled with rounded corners.

On the other hand, the back coupling end 3 of the portion 10 object of the present invention has a “V” shaped end edge 4 axially disposed along the body of blade 10. As can be seen in FIGS. 1 and 2, more specifically in this back end of coupling 3, a circular through-hole 5 is provided that is centered and lined with the longitudinal axle of blade 10; said circular through-hole 5 being disposed equidistant said axial end “V” shaped edge and small rectangular transversal thin tabs 6 that are incorporated to the side edge of the back end 3 of the laminar portion 10.

Immediately after this pair of tabs 6, the side edges of the coupling end 3 of the portion 10 is provided with a recess 7 having a substantially rectangular contour on its upper side and a substantially trapezoidal contour on its lower side, see FIG. 1, thus configuring a neck that prevents the back universal end 3 from coupling with the rest of the body 1 and 2 of the sawing blade 10 itself.

With this configuration of the coupling end 3, illustrated in FIGS. 1 and 2, the sawing blade 10 can be connected to any type and model of sawing device as illustrated in FIGS. 3, 4, 5, 6 and details thereof.

FIGS. the 3 and 3a show that the inventive sawing blade 10, when coupled to the actuating pin 11 of a Bosch® type device, has its back end 3 enclosed by the sleeve 12 of actuating pin, thus keeping its end edge 4 supported against a stopping pin 13 that, by means of a spring 14, urges the transversal tabs 6 of the universal end 3 against the inner face of the sleeve, thus holding firmly the sawing blade 10 to the actuating pin 11 of the machine. Thus, for this model of machine the elements that interact mechanically in the coupling thereof are: the end edge 4 and the transversal tabs 6 of the back end 3 of the blade 10.

FIGS. 4 and 4a show that the inventive sawing blade 10, when coupled to the actuating pin 21 of a lack & Decker® type device, has its back end 3 held by the radial mechanical pressure exerted by the sleeve 22 and the locking bolts 23 that connect the actuating pin 21 and compress the front and back faces of the coupling end 3, see FIGS. 4, 4a and 4b. Thus, the side edges of the coupling end 3 in front of the transversal tabs 6 of the universal end 3 remain compressed from above with the sleeve 22 and the actuating pin 21 while, simultaneously, the front and back faces of said end 3 are timely and alternatively compressed by the locking bolts 23. Thus, for this model of machine the elements that interact mechanically in the coupling is the peripheral contact of the universal end 3 portion between the end edge 4 and the side edges in front of the transversal tabs 6 of the back end 3 of the blade 10.

FIGS. 5 and 5a show that the present sawing blade 10, when coupled to the actuating pin 31 of a De Walt® type device, has its back end 3 held by the radial mechanical pressure on the conical bifid jaw 32 provided in inside the end of the sleeve 33. Thus, when axially and radially compressed by the jaw 32, the actuating pin 31 holds in its end the front and back faces and the side edges of the coupling end 3, provided in front of the transversal tabs 6 of the universal end 3. Thus, for this model of machine the elements that interact mechanically in the coupling also are the peripheral contact of the universal end 3 portion between the end edge 4 and the side edges in front of the transversal tabs 6 of the back end 3 of the blade 10.

Finally, FIGS. 6, 6a and 6b show that the inventive sawing blade 10, when coupled to the actuating pin 41 of a B&D 3157 or DW 313 type device, has its back end 3 enclosed by the sleeve 42 that is attached by a locking bolt 43 to the actuating pin 41. The coupling end 3 of the blade 10 is still held in the actuating pin 41 by a second locking bolt 44 that crosses the threads of the sleeve 42, the free end thereof axially incorporating a cylindrical portion 45 that is fit into the through-hole 5 of the coupling end 3 of the blade 10 attaching same to the end of the actuating pin 41. This way, for this model of machine the elements that interact mechanically in the coupling are the peripheral contact of the universal end 3 portion and the through-hole 5 of the blade 10.

Although a preferred constructive configuration has been described and illustrated, it should be pointed out that changes can be made and applied without departing from the scope of the present invention.

1-4. (canceled)

5. A saw blade comprising
a thin cutting portion,
a top edge, a bottom edge and a longitudinal axis equidistant from said top and bottom edge,
a coupling end, said coupling end having a V-shaped edge centered on said longitudinal axis,
a first tab on said top edge,
a second tab on said bottom edge,
a first recess next to said first tab,
a second recess next to said second tab, and
a through hole between said coupling end and said tabs.

6. The saw blade of claim 5, wherein
said through hole is centered on said longitudinal axis.

7. The saw blade of claim 5, wherein said through hole is centered between said coupling and said tabs.

8. The saw blade of claim 6, wherein said through hole is centered between said coupling and said tabs.

9. The saw blade of claim 5,wherein said tabs are rectangular.

10. The saw blade of claim 5, wherein
said first recess is rectangular and
said second recess is trapezoidal.

11. The saw blade of claim 5, wherein said through hole is circular.
